(19) United States
(12) Patent Application Publication
(10) Pub. No.: US 2026/0351443 A1
(43) Pub. Date: Nov. 5, 2026

(54) ELECTRICAL LOCAL CONNECTING BUSBAR

(71) Applicant: KK WIND SOLUTIONS A/S, Ikast (DK)

(72) Inventors: Jorgen Dahl Vestergaard, Kibaek (DK); Poul Thing, Ikast (DK); Bjorn Rannestad, Aalborg (DK)

(21) Appl. No.: 19/168,767

(22) PCT Filed: Mar. 22, 2024
(86) PCT No.: PCT/DK2024/050063

§ 371 Date: Sep. 24, 2025

(30) Foreign Application Priority Data
Mar. 28, 2023 (DK) PA202370156
Apr. 27, 2023 (DK) PA202370206
May 26, 2023 (DK) PA202370257

(51) Int. Cl. H01B 7/29; B33Y 10/00; B33Y 80/00; H01B 7/18; H01B 13/00

(52) U.S. Cl. CPC H01B 7/292; B33Y 80/00; H01B 7/1805; H01B 13/0006; H01B 13/0026; B33Y 10/00

(57) ABSTRACT

An electrical local connecting busbar and a method for making the same. The electrical local connecting busbar includes first and second terminals. The terminals are spaced apart by a middle segment configured to support conductance of an electric current between terminals. The electrical local connecting busbar is manufactured by additive manufacturing.

### FIELD OF THE INVENTION

The present invention relates to an electrical local connecting busbar and a method for manufacturing such electrical local connecting busbar by an additive manufacturing process.

### BACKGROUND OF THE INVENTION

In the art massive Copper and Aluminium busbars are known and used for distributing power in electric systems. Such busbars are heavy and difficult to handle both before, during and after mounting when they reach a certain size i.e. when they are to comply with requirements for conducting high currents such as currents above 16 A. Thus, a problem exists in the art relating to manufacturing, transport and mounting of busbars.

### SUMMARY OF THE INVENTION

The inventors have identified the above-mentioned problems and challenges related to electrical busbars and how to handle busbars and solved these problems by the present invention as described below.

In an aspect, the invention relates to an electrical local connecting busbar comprising at least one first terminal and at least one second terminal spaced apart by a middle segment configured to support conductance of an electric current between the at least one first terminal and the at least second terminal, characterized in that the electrical local connecting busbar is manufactured by additive manufacturing.

Manufacturing a high-power electrical local connecting busbar (referred to simply as conductor or electrical conductor) by an additive manufacturing process is advantageous in that additive manufacturing is suitable for manufacturing complex shapes and is thus advantageous to employ for manufacturing of electrical conductors where these are used in narrow spaces such as in an electrical cabinet. Particularly, geometrical features of the electrical conductor, such as individual conductor branches, outgrowths, recesses, internal structures, etc. may be directly manufactured additively. Thus, using additive manufacturing for manufacturing an electrical conductor of a high-power converter is advantageous since it may permit tailoring the geometry of the electrical conductor to the conditions/design of the high-power converter and/or the electrical cabinet comprising the high-power converter.

Hence, a converter comprising a local connecting busbar according to the present invention manufactured by an additive manufacturing process is advantageous in that weight and cost of materials are reduce due to less material being used for the electrical conductors. Further, cooling of the converter is improved in that surface area of the electrical conductor can be increased and the electrical conductor can be manufactured with internal cooling channels. Further, assembling of the converter may be faster due to a reduced number of connections of electrical conductors and to more flexible electrical conductors compared to known busbars. These effects may all contribute to a more compact design of e.g. a power converter using a local connecting busbar according to the invention.

Further, the electrical conductors may be designed to reduce airflow from an air inlet to an air outlet of an electric cabinet as little as possible. In fact, it may be possible to design the electrical conductors with a geometry that is guiding air flow in a predetermined direction. A predetermined direction may be towards a heat sink, a connection between conductor and component, an opening to an internal channel of the conductor, etc.

An electrical conductor may be implemented as a cable or a busbar. Busbars are in the art known as massive Copper or Aluminium bars which are typically used to distribute current between electrical components inside the electrical cabinet.

In an exemplary embodiment of the invention the electrical local connecting busbar is selected from the list comprising: main busbar, transition busbar and current balancing busbar.

A main busbar should be understood as an electrical conductor distributing current in an electrical cabinet, a switchgear, panel board or busway enclosure, typically, from one or more cables entering the electrical cabinet to electrical components located inside the electrical cabinet. Typically, the main busbar extends in the width (X direction) or in the height (Y direction) of the electrical cabinet. The main busbar may be fastened to the back plate of the electrical cabinet.

A transition busbar should be understood as a busbar connecting a main busbar or cable with another main busbar, another transition busbar, with an electrical component, or the like. A transition busbar may also be referred to as a connection or transition piece for connecting two or more electrical components. Typically, a transition busbar extends in two or more directions, where one of these directions is towards the opening of the electrical cabinet (Z direction). Another of these directions is typically perpendicular or parallel to e.g. the main busbar to which transition busbar is connected. The transition busbar may comprise two legs at one end for connecting e.g. two paralleled power modules to one main busbar or to another transition busbar.

A current balancing busbar should be understood as a variant of a transition busbar. A current balancing busbar may e.g. be a transition busbar where the two legs connecting the paralleled power modules are connected/shut circuited. This is advantageous in that it has the effect, that if the current balancing busbar is connected to two parallel connected power modules, and the current into or out of these two power modules are not the same, due to the connected legs heat and current is conducted in one larger leg. In this way the current and heat is balanced in the current balancing busbar.

In an exemplary embodiment of the invention the electrical local connecting busbar comprises a first end segment and a second end segment.

In an exemplary embodiment of the invention the end segments comprise at least one first terminal and at least one second terminal.

In an exemplary embodiment of the invention the middle segment comprises at least one first terminal and at least one second terminal.

The physical electrical conductor may be manufactured based on the digital representation.

Additive manufacturing permits simplified production of complex geometrical shapes, such as an electrical conductor according to the invention, which is advantageous. Particularly, geometrical features of the electrical conductor, such as conductor branches, may be directly manufactured additively, while establishing spatial separation of conductor branches in two different transversal directions.

Moreover, additive manufacturing may reduce the number of steps required for manufacturing, which is advantageous. However, note that embodiments of the invention are not restricted to a particular number of manufacturing steps.

Wire arc additive manufacturing may be particularly suited for manufacturing electrical conductors according to the invention relatively cheaply.

A middle segment may be understood as a segment electrically and mechanically coupling the first and the second terminals. In some embodiments, the middle segment might not necessarily be in direct contact with both end segments. It may, for example just be monolithically formed with the first end segment, whereas an additional segment is located between the second end segment and the middle segment.

This is advantageous in that the electrical conductor could be manufactured to fit directly into e.g., an electrical cabinet where a minimum of space is available. The electrical conductor could also be of another material in a segment due to space or other electrical components in the electrical cabinet.

In an exemplary embodiment of the invention the middle segment comprising a plurality of conductor branch elements.

This is advantageous in that it has the effect of using less material for making the electrical conductor. The conductor elements are having a greater surface area than the solid conductor, which can help cooling down the electrical conductor. The cooling at the greater surface areas for the conductor elements makes it possible to have the same current in the electrical conductor while having less material.

Note, that it is particularly challenging to reduce weight and amount of material of a component, such as an electrical conductor, which has requirements relating to vibrational damping, susceptibility to structural damage, and/or current carrying capabilities. Simply removing material may not be feasible since it may lower the capabilities of the electrical conductor below its requirements for a given application, e.g., a particular electrical installation in a particular renewable energy facility. Thus, the prospect of saving/removing material may be evaluated in combination with minimally reducing, maintaining, or even improving other attributes of the electrical conductor.

An electrical conductor may be understood as an object or element for facilitating flow of an electrical charge also referred to as current. An example of an electrical conductor is a busbar. Other examples of electrical conductors are cable or wire arrangements. A busbar may for example be used to connect high voltage and/or high current equipment or terminals in electrical converter installations within a wind turbine. Typically, a material of an electrical conductor is metal, for example silver, copper, gold, aluminium, one or more other metals, or any combination thereof.

An electrical conductor may for example be installed/integrated in electrical installation in a renewable energy facility. An example of an electrical installation is a converter, such as an AC-DC converter, DC-AC converter, AC-AC converter, or DCDC converter. Such converters are often crucial for correctly and reliably converting electrical power e.g. from one to another between the renewable energy facility and the electrical grid. Other examples of an electrical installations are an uninterruptable power supply (UPS), a power supply, a switch module, and electrical installations provided in electrical cabinets in general.

Examples of renewable energy facilities are renewable energy power plants such as wind turbines, photovoltaic power stations, hydropower power plants, bioenergy power plants, and geothermal energy power plants. Other examples of renewable energy facilities are power storage facilities such as battery-based power storage facilities, and power-to-x facilities such as electrolysis facilities. Also, an electrical conductor according to the present invention may be used in electric systems of electric vehicles.

In an exemplary embodiment of the invention the conductor branch elements are monolithically formed by rounded connections thus shaping concavely rounded interior corners with the at least one first terminal and/or the at least one second terminal.

An additive manufacturing process is suitable for manufacturing complex shapes and is thus advantageous to employ for manufacturing a middle segment formed by a plurality of conductor branches.

In an exemplary embodiment of the invention the at least one terminal, the at least one second terminal and the middle segment are monolithically connected.

An electrical conductor according to the invention may be used to facilitate damping of vibrations, e.g. in the electrical installation, which is advantageous. Particularly, by having an electrical conductor wherein the end segments are coupled electrically and mechanically by a plurality of conductor branches, via monolithically uniting rounded connections, which spatially separates conductor branches in two different transversal directions, the electrical conductor may be capable of improved vibrational damping in any of the transversal directions while potentially minimizing the risk of structural damage, which is advantageous.

Large currents and varying weather conditions may result in a large span of temperatures in renewable energy facilities. By having the plurality of conductor branches monolithically formed to the first end segment by rounded connections and distributed in two transversal directions, the electrical conductor may be able to better tolerate thermal expansion under such conditions, which is advantageous.

The so-called skin effect is the tendency that electrical AC currents tend to flow mainly near the surface of a conductor. This effect may introduce additional AC resistivity in conductors. By having a plurality of conductor branches, the surface area may potentially be increased, at least locally in the middle segment, thus reducing AC resistivity, which is advantageous. Simultaneously, rounded monolithic connections may facilitate the formation of the plurality of conductor branches in the middle segment while minimizing conduction loss which may otherwise occur at sharp corners and/or interfaces, which is advantageous.

In an exemplary embodiment of the invention the electrical local connecting busbar is manufactured in an electrically conductive material.

This is advantageous in that it has the effect, that the electrical conductor can conduct an electrical current. A few examples could be an electrical conductor made of either copper, aluminium or any current conducting material or alloys thereof.

In an exemplary embodiment of the invention the electrical local connecting busbar is manufactured in a non-electrically conductive material.

This is advantageous in the material used for manufacturing the electrical conductor is cheaper, lighter or faster. The electrical conductor could be coated/painted with a conductive material to conduct an electrical current after the electrical conductor is manufactured in a non-electrically conductive material.

In an exemplary embodiment of the invention the electrical local connecting busbar is coated or painted with insulating material.

In an exemplary embodiment of the invention the electrical local connecting busbar is coated or painted with an electrically conductive material.

This is advantageous in that the process for making the electrical conductor could be faster or cheaper when the electrical conductor is coated or printed afterwards with another material.

It could also be advantageous when the electrical conductor is applied in e.g., an electrical cabinet to apply an additional insulating material to avoid other electrical components.

The coated/painted material applied to the electrical conductor could be applied to the whole conductor but could also be applied to only an end segment, the middle segment, or an additional segment.

In an exemplary embodiment of the invention the electrical local connecting busbar comprises a geometry which is included in the list comprising: a wedge, cone, cylinder, square and ellipse.

Accordingly, any geometries possible to manufacture by an additive process may be used in any combinations to manufacture the middle segment of the electrical conductor.

In an exemplary embodiment of the invention the electrical local connecting busbar is manufactured in a geometry which is including in the list comprising: bionic, web, sponge, honeycomb, wavelike, gyroid-like and branch-like.

Such geometry of the electrical conductor is advantageous in that when one of the above-mentioned geometries are chosen, the amount of material used for the electrical conductor is reduced. It is also an advantage that the surface of such geometries of the electrical conductor is increased in that more surface is then available for cooling and conducting high frequency currents.

For all the bionic, web, sponge, honeycomb, etc. like geometries these structures, are good for cooling down the electrical conductor. The geometries all comprise less material with a big surface, so the smaller amount of material is easier to cool down and provides a more compact geometry/electrical conductor. Due to the more efficient cooling, it is possible to conduct the same amount of current in the electrical conductor of the present invention using less material compared to a known massive electrical conductor.

In an example the electrical conductor could comprise a shell structure and inside a grid of bionic, web, sponge, honeycomb like geometries. The material removed from the classical electrical conductor compared to an embodiment of an electrical conductor according to the present invention forms holes which may be used for cooling the electrical conductor.

In an exemplary embodiment of the invention the at least a middle segment of at least one of the electrical local connecting busbar comprises at least one internal cooling channel.

The internal cooling channel may be a closed cooling channel for guiding a liquid through the interior of the busbar or an open cooling channel for guiding an air flow through the interior of the busbar. It should be mentioned that guiding an air flow through the interior of the busbar should be understood as guiding air behind the outer surface of the busbar i.e., along the side or behind a conductor branch of the busbar. Accordingly, it is understood that the conductor, in particular part of the middle segment of the conductor is manufactured with a plurality of conductor branches forming air gaps through which air can flow.

An internal cooling channel configured to guide a cooling fluid through at least part of the electrical conductor is advantageous in that in this way, the temperature of the electrical conductor, especially around the internal cooling channel, can be controlled such as reduced. Hence, an internal cooling channel is advantageous in that it has the effect, that an efficient temperature regulation of the electrical conductor is possible.

Further, internal cooling channels are advantageous in that heat is transported out of the electrical cabinet more efficiently than by using a fan to establish a flow of air out of the electrical cabinet. Since, at the high amps a power converter of the present invention is operating at, heat is a very important design factor. Thus, the better the temperature can be controlled, more efficient it is possible to operate the power converter. Therefore, it is important to be able to remove as much heat as possible from the inside of the electrical cabinet.

Accordingly, electrical conductors having both an internal cooling channel for liquid fluid and a bionic-like geometry is advantageous to use for conducting current inside an electrical cabinet comprising a power converter operating with currents above 500 A.

In this document is mentioned a first, second and third cooling loop. It should be noted that these cooling loops may be combined in any desired way to optimize the cooling of the high-power converter.

Having more than one internal cooling channel is advantageous in that it has the effect, that the electrical conductor then has more surface when high frequency current is conducted due to the skin effect. Further, this is advantageous in that it has the effect, that a larger part of the cross-sectional area of the electrical conductor is possible to temperature regulate. Further, this is advantageous in that it has the effect, that cooling fluid having different temperatures can flow through the electrical conductor. A plurality of cooling channels also allows to circulate the same cooling fluid forth and back between the ends of the middle segment/first and second ends. Alternative, it allows to have several separate flows.

In an exemplary embodiment of the invention the at least one internal cooling channel is configured to comprise a cooling pipe.

A cooling pipe/polymer tube e.g. in the form of an insulated hose may be inserted into the internal cooling channel e.g. when the electrical conductor with internal cooling channel is manufactured. This is advantageous in that it has the effect, that no connection of external cooling channel and internal cooling channel is needed. The cooling pipe may simple be circulating the cooling fluid from a heat exchanger to through the electrical conductor via the internal cooling channel and back to the heat exchanger.

Flow guides are advantageous in that they have the effect that they may be designed to establish a particular flow of cooling fluid inside the internal cooling channel. Such particular flow may include establishing a swirling effect in the flow of cooling fluid inside the internal cooling channel and thereby increase cooling effect of the cooling fluid.

Monolithically uniting the internal cooling channel and at least part of an external (to the electrical conductor) cooling channel is advantage in that mounting of the internal cooling channel to a cooling system is easy. In fact, an additional part of the external cooling channel such as a plastic pipe may be connected to the part of the external cooling channel monolithically formed with the inner cooling channel with a hose clamp.

In an exemplary embodiment of the invention, said high-power electrical conductor has a resonance vibration frequency of at least 5 Hz, for example at least 20 Hz, for example at least 30 Hz, for example at least 70 Hz, for example at least 150 Hz for example at least 300 Hz, for example at least 500 Hz.

The electrical conductor is advantageously designed and subsequent manufactured so that it has a resonance vibration frequency associated with relative motion between the first end segment and the second end segment that is does not coincide with a natural frequency of the system in which it is included. This is to avoid vibrations initiated by natural frequencies from such electric system or mechanical system. An example of a mechanical system is a wind turbine which may have a natural frequency of 5 Hz. The resonant frequency of the conductor may be changed by applying a structure e.g. along the length or width of the conductor with the only purpose of avoiding a particular resonant frequence. The structure may include a protrusion, wedge, etc.

In an exemplary embodiment of the invention, said first or second end segment is U-shaped or E-shaped.

This is advantageous in that it has the effect, that the connection between two busbars is made with an increase area/surface leading to a more efficient current flow and thus a reduction in electric losses.

In an exemplary embodiment of the invention, wherein the middle segment of said electrical local connecting busbar comprises curved area.

In an exemplary embodiment of the invention, wherein the middle segment (4) of said electrical local connecting busbar comprises twisted area.

The curved or twisted areas are advantageous in that they have the effect, that no physical connections of two or more busbars are needed to change direction and/or orientation of end segments. This is leading to an increase in mounting time and a reduction in electrical losses.

In an aspect of the invention the electrical local connecting busbar according to any of the above paragraphs is manufactured according to the method of any of the below paragraphs.

In an aspect of the invention relates to a method of manufacturing an electrical conductor comprising a middle segment having a non-uniform design, the method comprises the step of by an additive manufacturing process:
provide a first layer of electrically conductive material,
provide a plurality of subsequent layers of the electrically conductive material thereby forming a first end, a middle segment and a second end of the electrical conductor,
wherein the method is characterized in that a layer of the electrical conductor added to a previous layer of the electrical conductor is forming a non-uniform cross-sectional area of the middle segment.

In an exemplary embodiment of the invention the method of manufacturing an electrical conductor the electrical conductor is an electrical local connecting busbar.

In an exemplary embodiment of the invention the method of manufacturing an electrical conductor the electrical conductor is selected from the list comprising: main busbar, transition busbar and current balancing busbar.

It is advantageous to manufacture an electrical local connecting busbar by additive manufacturing so the entire electrical local connecting busbar can be manufactured in one piece. An additional advantage by manufacturing the electric conductor in one piece is that the holes for either mechanically fastening or terminals is made in the process of additive manufacturing and not by removing material away from the electrical conductor.

It is also advantageous in that the electrical conductor can be manufactured in specific shapes and dimension according to where the electrical conductor is supposed to be used. The electrical conductor could be made more “airy” in space, which allow to optimize the cooling for the electrical conductor and to save material. The electrical conductor could be shaped to curve around other electrical components in e.g., an electrical cabinet, or to have a greater distance to other electrical components to ensure electrical insulation.

In an exemplary embodiment of the invention the method of manufacturing an electrical conductor the electrical conductor is braided from a plurality of additive manufactured conductors while being printed.

It is advantageous to use additive manufacturing for an electrical conductor, where additional layers can be added while the electrical conductor is being braided. The braided electrical conductor is advantageous in it is more flexible and therefore could fit into more electrical settings or be used to connect electrical components.

In an exemplary embodiment of the invention the method of manufacturing an electrical conductor the electrical conductor connecting busbar is additive manufactured by an additive manufacturing process of any one of the list: Cold spray, binder jetting, Stereolithography (SLA), Selective Laser Sintering (SLS), Fused Deposition Modeling (FDM), Digital Light Process (DLP), Multi Jet Fusion (MJF), Poly Jet, Direct Metal Laser Sintering (DMLS) or Electron Beam Melting (EBM).

A lot of different methods can be used to manufacture the electrical conductor. It is advantageous to have different methods to manufacture the electrical conductor so different materials or different state form of the materials could be used.

In an exemplary embodiment of the invention the method of manufacturing an electrical conductor the electrical conductor is manufactured horizontally or vertically.

It is advantageous to additive manufacture in both horizontal and vertical depending on the geometry of the electrical conductor. The orientation of the electrical conductor when being printed could save material or make the printing process faster. The orientation of the electrical conductor when being manufactured could also be advantageous when some specific geometries are manufactured e.g., a braided geometry is manufactured vertically due to the space between conductor branches.

In an exemplary embodiment of the invention the method of manufacturing an electrical conductor the electrical conductor is manufactured so that one of the dimensions of the electrical conductor is manufactured larger than one of the dimensions of the printing volume of the device used for additive manufacturing.

It is advantageous to print electrical conductors in any length or width to have electrical conductors printed directly to a specific place in e.g., an electrical cabinet.

Printing volume should be understood as the volume inside an additive manufacturing device e.g., 3D-printer, where the final product of the additive manufacturing process is being made. The printer volume typically sets the dimensions of the available sizes an electrical conductor could have as a maximum length, height and width. Therefore it is advantageous to keep the additive manufacturing process running while pulling out the electrical conductor at the same time to exceed either the maximum length, height or width of the electrical conductor. The electrical conductor could at the same time be rolled up upon e.g., a drum to make a very long electrical conductor.

In an exemplary embodiment of the invention the method further comprises the steps of connecting a first conductor and a second conductor by:
providing the first conductor,
providing the second conductor, and
mechanically connecting the first conductor with the second conductor thereby forming a multi part electrical conductor.

In an exemplary embodiment of the invention the method of manufacturing an electrical conductor the first conductor and the second conductor are mechanically connected with cover plates.

It is advantageous to mechanically connect electrical conductors with cover plates to ensure the electrical connection between two conductors. The mechanical connection should be tight and without airgaps for optimizing the electrical connection between the electrical conductors. Thus, the method could be said to facilitate the establishing of a conductor system comprising a first conductor and a second conductor manufactured according to the method described above and where the conductor system is provided by mechanically connecting the first conductor and the second conductor.

In an exemplary embodiment of the invention the method of manufacturing an electrical conductor the first conductor comprises a male connecting piece and the second conductor comprises a female connecting piece.

Here male connecting piece should be understood as an additional part of the conductor, which is also manufactured by additive manufacturing while manufacturing the conductor. The female connecting piece should be understood as a part of the conductor where additional manufacturing was not applied doing the manufacturing process and thereby leaving space for the male connecting piece.

The male and female connecting pieces could be e.g., a dowel and a hole with the same dimensions configured to connect the two conductors mechanically and electrically.

In an exemplary embodiment of the invention the method of manufacturing an electrical conductor the male connecting piece and the female connecting piece are a screw-locking mechanism.

This is advantageous in that when fastening and/or connecting the two parts the screw is pulling the parts together at the same time it is being screwed.

In an exemplary embodiment of the invention the method of manufacturing an electrical conductor the first conductor and the second conductor are mechanically connected with cover plates and a male and female connecting piece.

The combination of both cover plates and male/female connecting pieces are advantageous when a more tight and fast connecting between two conductors is used to ensure a better electrical connecting between the conductors.

In an exemplary embodiment of the invention the method of manufacturing an electrical conductor the first conductor and the second conductor are mechanically connected with a plastic, thermal paste, or glue between the two conductors.

This is advantageous to ensure a better mechanically and electrical connection between the electrical conductors. An alternative could be welding the two electrical conductors together or to use some heat two “melt” them together.

In an exemplary embodiment of the invention the method of manufacturing an electrical conductor the male connecting piece and the female connecting piece comprises a cooling channel.

It is advantageous to have a cooling channel connection between two electrical conductors where the mechanically connection is to have more tight mechanical connection for the cooling channel to prevent it from leaking.

In an exemplary embodiment of the invention the method of manufacturing an electrical conductor the electrical conductor after connecting the first and second conductor has a larger volume than the additive manufacturing volume.

It is advantageous to print only a segment of the electrical conductor and afterwards connect the segments. The segments could be manufactured simultaneously at different additive manufacturing machines and therefore save time in the printing process. It is also advantageous to print the segments individually when the electrical conductor is larger than the printing volume of the additive manufacturing machine.

Another advantage of printing each segment individually is that the segments could be connected directly in e.g., an electrical cabinet where one or more segments must connect around another component e.g., an electrical component or a cooling channel/member. The segments could also be connected around another component that needed to be enclosed inside the electrical conductor e.g., a cooling channel.

In an exemplary embodiment of the invention the method comprises a step of coating or painting the electrical conductor with either an insulating material or an electrically conductive material after the last layer of the electrically conductive material has been added.

It is advantageous to either coat or print an insulation material or electrically conductive material to the electrical conductor after the additive manufacturing. Combining insulating and conducting material in one assembly which is at least partly 3D-printed or otherwise manufactured by additive manufacturing, may be highly advantageous, as it facilitates more freely designing shapes, geometries, profiles, etc., of the conductor assembly, for example when utilizing the opportunity in additive manufacturing of producing geometries or profiles that would not be possible to manufacture by traditional methods like moulding or extrusion. Likewise, new features of electrical conductor assemblies may be facilitated by the present invention, which are also not possible or feasible to achieve with traditional methods. Advantageously, a 3D-printed electrically conducting component may be coated or otherwise provided with electrically insulating material to form the electrical conductor assembly. The surface treatment providing the electrically insulating component may apply to the entire surface of the conducting material, possibly except the terminals thereof, or it may be applied partially, for example at selected portions of the conductor surface, for example where a sufficient safety clearance air gap to nearby conducting parts is not feasible, or to reduce the risk for operators or service technicians. Surface treatment, as used here and elsewhere herein, may comprise any technology or process of applying or creating a substance on a surface of another substance. Surface treatment may for example comprise coating with a separate substance, where examples of suitable coating methods comprise painting, spraying, dipping, powder coating, plating, shrinking, physical or chemical vapor deposition PVD/CVD, low temperature arc vapor deposition LTAVD, ion beam assisted deposition IBAD, etc. Surface treatment may alternatively or in addition comprise conversion coating, where a surface is modified to achieve different properties, where examples of suitable conversion coatings comprise chromating, phosphating, anodizing, hard anodizing, patination, plasma electrolytic oxidation PEO, etc.

### THE DRAWINGS

For a more complete understanding of this disclosure, reference is now made to the following brief description, taken in connection with the accompanying drawings and detailed description, wherein like reference numerals represent like parts. The drawings illustrate embodiment of the invention and elements of different drawings can be combined within the scope of the invention:

FIG. 1a illustrates a first electrical local connecting busbar with a twisted geometry,

FIG. 1b illustrates a second electrical local connecting busbar with a weblike geometry,

FIG. 1c illustrates a third electrical local connecting busbar with a bionic design,

FIG. 2 illustrates a flow chart for manufacturing an electrical local connecting busbar,

FIG. 3a illustrates an electrical local connecting busbar form as a wedge,

FIG. 3b illustrates an electrical local connecting busbar from a side perspective,

FIG. 3c illustrates a cross-sectional view of the electrical local connecting busbar from 3a at the cross-section A, and

FIG. 4 illustrates an electrical local connecting busbar having U-and E-shaped end segments.

### DETAILED DESCRIPTION

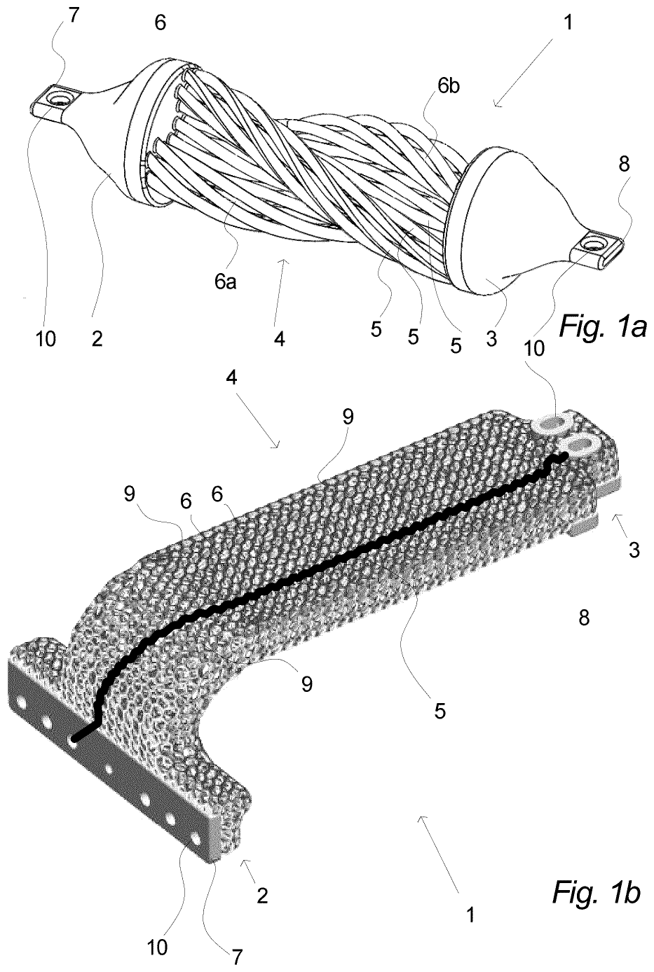

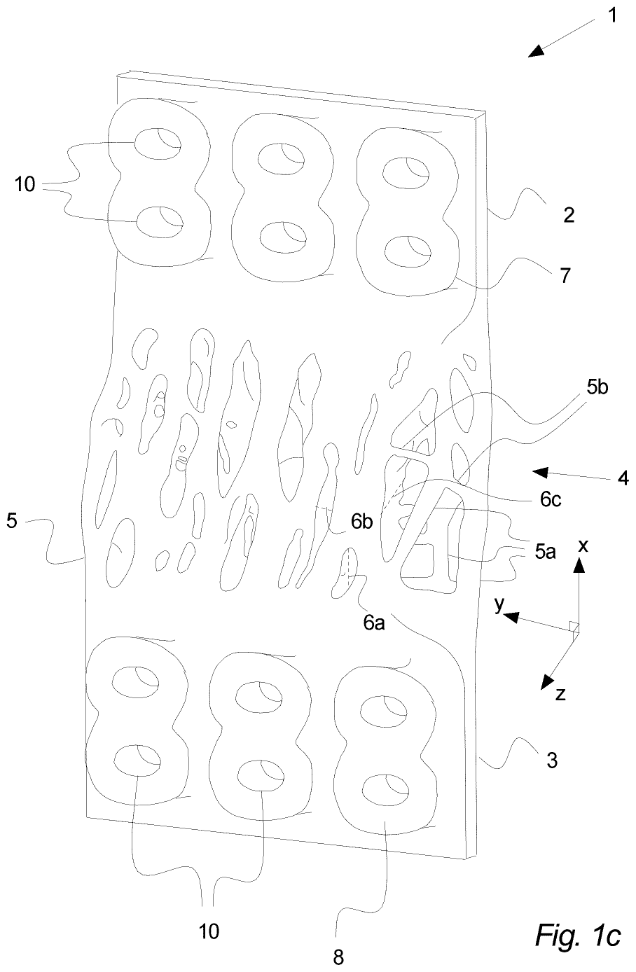

FIG. 1a-1c illustrates various embodiments of an electrical conductor 1 according to the present invention. FIG. 1a illustrates an electrical conductor 1 having a twisted geometry/design. The electrical conductor 1 comprises a first end 2 and a second end 3, where the second end 3 being distal to the first end 2 and spaced apart from each other by a middle segment 4.

The middle section 4 in this particular embodiment comprises a plurality of conductor branches 5. In this particular embodiment the individual conductor branches are spaced apart by air gaps 6 both in the longitudinal and 6a transversal direction 6b of the electrical conductor 1. This twisted design of the conductor branches adds flexibility to the conductor 1 and thus the ability to absorb vibrations. Further, the design is lightweight and easy to mount.

In this particular embodiment, the first end 2 comprises a first terminal 7 and the second end 3 comprises a second terminal 8. The first and second terminals 7, 8 may comprise one or more terminal holes 10 for connecting the electrical conductor 1 to other electrical components. The electrical conductor 1 is configured to support conductance of an electric current between the first and second terminals 7, 8.

Each of these two terminals 7, 8 may, via terminal holes 10, clamps, plugs or other electrical connection means, for example be galvanically coupled to terminals, busbars, components (such as breakers, contactors, power modules, reactors, etc.) and other electrical conductors according to the present invention, etc. of an electrical installation. Typically, the electrical conductor 1 and thus the terminals, busbars, components, etc. to which it may be connected would be comprised by an electric box i.e. located inside an enclosure such as a panel, cabinet, etc.

In various embodiments, the electrical conductor 1 may have several first ends 2, several second ends 3, several first terminals 7, and/or several second terminals 8.

FIG. 1b illustrates an electrical conductor 1 having a web-like or lattice-like geometry/design. As the electrical conductor 1 illustrated in FIG. 1a, the electrical conductor illustrated in FIG. 1b comprises a first end 2 and a second end 3 separated by a middle section 4. The first end 2 may comprise a first terminal 7 and the second end 3 may comprise a second terminal 8. The first and second terminals 7, 8 may comprise one or more terminal holes 10 for connecting the electrical conductor 1 to other electrical components.

Between the two terminals 7, 8 conductor branches 5 in a web-like structure extend (only one is highlighted). These conductor branches meet and branch off in a plurality of intersection points 9. Note that the first and second ends 2, 3 are also partly manufactured as a web-like design as the middle segment 4. Also note, that the first and second terminals 7, 8 comprise more than one terminal hole 10. The terminal holes 10 of the terminals 7, 8 is made in a part of the ends 2, 3 which has non-perforated surface i.e. a surface different from the web-like surface of e.g. the middle segment 4 of the electrical conductor in this particular embodiment. The planar contact surface of the terminals 7, 8 around the terminal holes 10 is preferred to provide a connection surface to another flat surface with as little resistance as possible and sufficiently strong contact surface between bolt/nut and electrical conductor 1.

FIG. 1c illustrate an electrical conductor having a bionic geometry/design. As the electrical conductor 1 illustrated in FIG. 1a and 1b, the electrical conductor illustrated in FIG. 1c comprises a first end 2 and a second end 3 separated by a middle section 4. The first end 2 may comprise a first terminal 7 and the second end 3 may comprise a second terminal 8. The first and second terminals 7, 8 may comprise one or more terminal holes 10 for connecting the electrical conductor 1 to other electrical components.

The middle segment 4 in this embodiment is of a so-called bionic design, preferably achieved as a computer generated design. Such computer-generated design is provided based on input to a computer program controlling an additive manufacturing machine/process or able to export data to a controller of an additive manufacturing machine/process such as from a user or another computer. Input may include dimension, maximum current to be conducted, required strength, maximum deflection (elastic or plastic), etc. As the electrical conductor illustrated in FIG. 1b, the electrical conductor of this particular embodiment comprises both longitudinal conductor branches 5a and transversal conductor branches 5b. It is noted, that together the conductor branches 5a, 5b forms a transversal conductor branch outgrowth i.e. if seen in a side view, the electrical conductor 1 of FIG. 1c would be thicker at the middle section 4 than at the ends 2, 3. The conductor branches 5 are spaced apart in space by air gaps 6 in both X (6a), Y (6b) and Z (6c) directions. Further note, that the terminals 7, 8 are designed with a planar surface to obtain best possible contact with a component having a planar surface, to which the electrical conductor 1 is to be connected to, such as clamped against, via for example bolt and nuts. Also note, that independent from the geometry of the ends 2,3, the terminals 7,8 are aligned/raised so that the contact surface for, e.g., all three terminals 7 are in the same plane.

The above embodiments of an electrical conductor 1 all feature airy geometries having air gaps 5 between conductor branches 6. The electrical conductor 1 of the present invention may in other embodiments feature other airy geometries such as web-like, gyroid-like, lattice-like, etc., as described in more detail herein, which in various embodiments may provide improved cooling, reduced material consumption, improved flexibility, and/or other advantages described in more detail herein. The term ‘-like’ is used in connection with gyroid-like, lattice-like, etc., to emphasize that it is an airy geometry resembling the named structure, rather than a specific systematic structure, that is relevant in preferred embodiments of the invention.

In an embodiment, the electrical conductor comprises a plurality of conductor branches of which two or at least three are mutually spaced in both a transversal and in a longitudinal direction. Looking along the length of two conductor branches, they may be space e.g. in one of the transversal directions (Y and Z FIG. 1c) and/or in the longitudinal direction (X FIG. 1c). Such two conductor branches may be space with a third conductor branch in one or two of the directions (X, Y, Z) in which the two conductor branches are not spaced.

Such airy design may result in that no matter from which orientation the electrical conductor is seen more than one conductor can be seen. More specific, such design comprise openings/airgaps between two conductor branches no matter from which orientation the conductor branch is seen. Hence, no matter from which orientation a person is looking at the electrical conductor it is possible to see through the conductor. Further, such design may alternatively result in at least one opening/outlet for a flow of air through the electrical conductor from any orientation (at least from any angle around the longitudinal axis of the conductor) i.e. air can enter or leave the electrical conductor from any angle, at least from any angle around the longitudinal axis of the electrical conductor. This is contrary to e.g. braided conductors through which an air flow is not allowed to pass through at least through the width (Y of FIG. 1c) of the braided conductor. It could be argued that through the height (Z of FIG. 1c) of a braided conductor air flow is allowed, however such air flow will not have a cooling effect on all conductor branches it passes as would be the case with a conductor of the above-described design of the present invention. In fact, directing a flow of air to a braided busbar would result in that the airflow is not going through the conductor but instead around the conductor because the individual conductor branches are braided (touching each other) forming a closed middle segment through which an airflow cannot pass through.

An example of the above design is introducing line of sight through the electrical conductor. Line of sight may be understood as being able to see through the electrical conductor in fact it may be possible to have line of sight through the electrical conductor from any angle around the longitudinal axis of the electrical conductor. Such design has an advantage of providing airflow inlet through the electrical conductor from any such angle.

An example of the above design allows to see one conductor branch through an airgap between two other conductor branches. This may be true for any orientation i.e. in any angle around the longitudinal axis of the conductor. This allow a flow of air to impact all three conductor branches.

An example of the above design does not allow to see through the electrical conductor from any angle around the longitudinal axis of the electrical conductor. Hence it is possible to see into the interior of the electrical conductor but not all the way through the electrical conductor. This allows for a guidance of a flow of air to cool the electrical conductor inside or through the electrical conductor.

An example of the above design includes a plurality of airgaps on two or more sides/surfaces of the contour of the electrical conductor where it is possible to, simultaneously, see through a plurality of airgaps positioned opposite the contour of the electrical conductor and thereby through the electrical conductor.

The above design inherent a plurality of the advantages described in this document. A common advantage of the above design is a reduction of material, improved or controlled flexibility and improved or controlled cooling including individual cooling of each individual conductor branch preferably from any angle of the longitudinal axis of the conductor branch e.g. via a flow of air or other coolants.

When referring to an angle above, the angle may be perpendicular to the longitudinal axis of the electrical conductor or to a conductor branch.

It should be noted that the three different designs of electrical conductors of the present invention illustrated in FIG. 1a-1c is not limiting for the designs or geometries or structures that is possible to manufacture according to the present invention. Other designs that are possible to represent digitally and transfer to an additive manufacturing device and thus manufacture by additive manufacturing is considered to fall with the scope of the present invention. This includes designs having plane surfaces with internal ducts, manufactured by different materials, manufactures with protrusions or recesses, manufactured to have auxiliary functions beside conducting current, etc. Particularly, high-power conductors are advantageous to manufacture according to the present invention.

Note that embodiment of the invention, such as the above-described electrical conductors, may comprise further terminals 7, 8 between the ends 2, 3, which are not illustrated. Also note, that a plurality of the illustrated electrical conductors 1 may be connected to form a complete electrical conductor. In this case the first and second end 2, 3, is referred to as the ends of the complete electrical conductor which may comprise terminals 7,8 and e.g. terminal holes 10 for connecting the complete electrical conductor to other components. Between these first and second ends 2, 3 of the complete electrical conductor, terminals 7, 8 of a plurality of electrical conductors as illustrated may be connected.

The cross-sectional area of the conductor/conductor branches can be exploited to its full potential in an electrical conductor of the present invention. The conductor is designed and manufacture to have a cross-sectional area that is able to comply with requirements to current to be conducted without have excess of material used. The design of the present conductor may not have surplus material which is not used for conducting current when nominal current is supplied e.g. to a 1400 A power module. If extra material is used, this is used for cooling the conductor or a safety margin. The amount of such extra material can be determined relatively precise by the software which is used to design the conductor. As a rule of thumb, the larger surface for cooling, the higher amps is possible to conduct. The design software may be able to put weight on amps, cooling properties (cooling medium, surface, etc.), frequency of the current when designing the geometry of the conductor, etc. when designing the conductor. Accordingly, a conducting cross-sectional area of a conductor as illustrate in FIG. 1b may be 80 mm2 may in certain embodiments be sufficient to conduct a current of 1300 A due to the airy design allowing a very advantageous cooling. In fact, tests have shown that the temperature of a conventional massive busbar with a conducting cross-sectional area of 516 mm2 conducting 1300 A increases to a temperature where neighbouring components of plastic is in risk of melting.

Hence, it should be noted that the conductor may be designed and subsequently manufactured so that a percentage of the cross-sectional area of the electrical conductor e.g., above 80% such as between 90% and 100% is used to conduct current during normal operation. This is in contrary to known massive busbars that does not exploit the material in its center to conductor current. This is at least true for most frequencies of currents conducted in high-power systems including renewable systems, vehicles and the like.

The high percentage of utilization of cross-sectional area for conducting current compared to known massive conductors is possible to obtain in that the conductor of the present invention and thus the individual conductor branches because they are designed with a cross-sectional area that sums up to be able to conduct a current of a given frequency. Further, the material reduction is also made possible because of the possibility of cooling also inside the conductor. In fact, a conductor branch may along most of its length, in some embodiments along all of its length, be cooled from all angles i.e. a 360° cooling of the conductor branches is possible.

As mentioned, a conductor of the present invention may form an airy geometry which depending on the kind of airiness may not facilitate a secure or robust platform or structure for fastening the conductor e.g. to the electric cabinet. Accordingly, in proximity of through-holes for fastening the conductor or through-holes, e.g. terminal holes, for connecting the conductor to components or other conductors, the geometry of the conductor may not be airy. Preferably, around a through-hole the density of the conductor is higher or more concentrated to form an, e.g., planar surface and thereby provide the best possible preconditions for conducting current between two parts of a joint and to distribute the force required to fastening a conductor in the joint or to a support structure. Hence, a through-hole may be designed as a cylinder through which a bolt may pass through and with planar upper and lower parts extending from the periphery of the cylinder to facilitate the force and/or current distribution in the joint. Other mounting and/or terminal points may be preferred in some embodiments, such as flanges, protrusions, plugs or sockets, etc., with or without through-holes, but with the same consideration of ensuring sufficient robustness and stability of the electrical conductor for the intended mounting or connection method. The through-holes could be 6 mm, 8 mm, 10 mm or 12 mm in diameter.

It should be mentioned that terminals for electrical connection may be positioned at or between the ends of an electrical conductor. Thus, in principle, a conductor may be manufactured by an additive manufacturing process and when the first end and first part of the middle segment is manufactured these may be rolled onto a conductor holder as the middle segment is continued to be manufactured. Alternative, the conductor is guided out of the printing areas e.g. by a conveyer belt as the conductor is manufactured. This may result in a long conductor with two ends. Either during manufacturing or after, terminals may be made in the conductor and also after manufacturing, the conductor may be cut into desired lengths. In this way, terminals may be manufactured or provided either at the ends or between the ends of the conductor.

The term monolithic is in this description used to describe the geometry or structure of an electrical conductor according to the present invention. Such conductor is preferably manufactured by an additive manufacturing process and thereby, it is manufactured as a single piece, unit or block from one end to the other or at least one end and a middle segment is manufacture as a single piece. Such conductor may thus be formed from a single material as a single piece, unit or block where its one or more ends are monolithically formed with a middle segment connecting the one or more ends i.e. monolithically united or formed should be understood as made in one continuous process with no need for additionally adding one part to another I.e. one or more ends are manufactured together with the middle segment as one unit with no connections such as welding, soldering, or by any clamping or fastening means, except for the type of micro binding intrinsic to the particular additive manufacturing technology utilized, such as, e.g., layer-by-layer melting, sintering, liquid binding, spraying, etc. With this said, it should be mentioned, that it is possible to add additional elements such as terminals, cooling fins, etc in a post manufacturing process e.g., by a cold spray process.

Put in another way a conductor of the present invention is the result of a process forming the conductor in one structure, a conductor composed of an electrically conductive material without joints, soldering's, welding's or seams and thus constituting a conductor as a rigid whole exhibiting a rigidly fixed uniformity. To such conductor it is possible to connect additional conductors via terminals and thereby branch off one current path to two or more current paths or vice versa. Such branching off may either be at the within the fixed uniformity of the conductor and/or it may be from one conductor to another e.g. via a joint/fixing of two conductors.

It should be mentioned that the conductor may be manufactured from more than one type of material. In this situation, the conductor could be said to be polylithic. The term polylithic should in this context be understood as a geometry or structure of an electrical conductor that is manufactured in one piece as a monolithic structure, as described above, where the conductor is manufactured from two or more materials. Hence, a polylithic conductor of the present invention is a conductor resulting from a process forming the conductor in one structure where the process is using two or more different materials. Such two or more materials may be a combination of electrical conductive or non-conductive materials.

In most embodiments, the electrical conductor 1 is designed to comply with high voltages i.e. voltages above 24V such as 110V, 230V, 400V, 690V, 1000V, 1500V and up to kV systems. just to mention a few voltage levels of an electrical installation in which the electrical conductor 1 of the present invention would be suitable. In terms of current, an electrical conductor 1 according to the present invention may be designed to conduct several hundreds of amps (16, 32, 64, and so on up to 100, 200 and so on up to e.g. 900 A) up to a couple of thousand amps (1000 A-3000 A). Electrical conductors may be designed to conduct higher currents than 3000 A e.g. by improving cooling of the conductor in combination with an increased cross-sectional area of the conducting part of the conductor.

Mentioning these voltages, it should be noted, that in principle there are no lower limits as to the voltage and current. I.e., versions of the electrical conductor may be designed to be used in, e.g., 3.3V, 5V, 9V, 12V, 15V, 20V, 24V or 48V systems, such as USB power delivery PD systems, conducting currents below, e.g., 10 A, such as 5 A, 3 A, 2.4 A, or 2 A just to mention a few examples.

Thus, the electrical conductor 1 of the present invention is suitable for use in almost any type of electrical installation. This includes everything from low voltage to high voltage AC and or DC systems where transfer/conducting of current or communication signals is needed.

The present invention is particularly advantageous for electrical busbars designed for high-power electrical systems, e.g. from 10 kW and up, such as 22 kW, 50 kW, 110KW, 150KW, 225KW, 300 kW, 350KW, 500 kW,800 kW,1 MW, 2 MW, 3 MW, or even higher, such as e.g. 5 MW or 10 MW systems, with voltages of e.g. 110V, 230V, 400V, 690V, 800V, 1000V, 1500V, 6 kV or e.g. 10 kV, and currents from e.g. 16 A, 32 A or 64 A, to several hundreds, e.g. 100 A, 200 A or 500 A, or even thousands, e.g. 1000 A to 4000 A. By local connecting busbar is referred to busbars for local connections inside such a high-power electrical system, e.g. contained inside an electrical cabinet housing a power converter, inverter, transformer, generator, electric motor, breaker, high-power battery system, battery charger, or similar power systems, possibly including capacitors, reactors or inductors, power resistors, dump loads, etc. A system, component or conductor may be categorized as a high-power system, component or conductor if it is operating at currents in the range of 800-1000 A or higher.

Non-limiting examples of such electrical installations/systems include energy facilities such as grid components such as substations with grid support, voltage regulation, power to x plants, etc., energy generating systems such as wind turbines, wind farms, solar plants, etc., electric installations in a private homes and industry, industrial machines, household appliances, etc. and means for transportation such as airplanes, heavy duty vehicles, light duty vehicles such as automobiles, trains, ships, etc.

Accordingly, the electrical conductor may be a high-power electric conductor of a high-power electric system. In a high-power electric system, conductors may be spaced apart and/or isolated from each other with greater distances than what is possible e.g. in an electrical motor. This distance is referred to as a safety clearance and the size of it depends on the voltage differences in the system. Thus, when depending on air as isolator between an otherwise non-isolated busbar/conductor and another conductor or structure of conductive material such as a metal cabinet, the distances must be taken into account in compliance with safety regulations. It should be mentioned that air quality/pollution degree, such as humidity and particle content, may also be relevant for the distance of the safety clearance. In case a conductor is used in a high-voltage system the surface is manufactured to reduce field concentrations.

Further, the cross-sectional area of a current path through a conductor according to the present invention is larger than the cross-sectional area of e.g. a winding of an electric motor. This may be true both with respect to a cross-sectional area at a given point of the conductor and over a distance of e.g. 20 cm or 30 cm in the longitudinal direction of the conductor and physical dimensions.

Current conducting busbars of a high-power installation or system is typically fastened to a structure comprising the system for every 25-35 cm. If the current is conducted by cables, the distance between cable fasteners may be even smaller. The fastening may be made by screwing bolts into a support structure such as an electric cabinet or by screwing clamps to the support structure which is then closed and thereby fastening the cable/busbar. The conducting cables/busbars are of course insulated from the support structure.

In such high-power installations where the primary aim of conductors is to distribute electric energy to components, the magnetic field around a conductor of the present invention is not as important as it is e.g. around a winding of an electrical motor. Thus, since the magnetic field is not the main purpose for manufacturing the electrical conductor for a high-power installation the conductor is typically not designed to have a certain magnetic field when conducting current.

Further, again comparing to e.g. a winding of an electrical motor, a conductor of the present invention would as a general rule be designed with a surface area that is as large as possible to optimize the possible advantages of the invention as described herein. Depending on the purpose of the conductor, the surface may for example be designed for conducting current, conducting current and heat dissipation or heat dissipation. Thus, even though all portions of a conductor of the invention may comprise an electric conductive material, not all portions are necessarily used for conducting current through the conductor. In general, the available area around a conductor is exploited to expand the surface of the conductor for one of, for example, the heat dissipation or current conducting purposes, or other described purposes such as improved flexibility, reduced material consumption, air guidance, etc. The available area is limited by safety clearances to other conductors of different phases having different voltage levels, grounded structures such as elements of an electric cabinet, etc.

An example of a portion of a conductor that is primarily used for non-conducting purposes such as heat dissipation or air guidance, is an outgrowth from the surface of the conductor which is not connected at the distal end of where it is growing from the surface of the conductor. Such outgrowth or protrusion may for heat dissipation purposes preferably comprise some kind of bionic design with airgaps between branches, possibly with a continuous surface towards a direction of air flow for air guidance purposes. Such portions would be referred to as conductor branches if these were part of the middle segment conducting current form one end to the other. Such outgrowth may in principle take any form or geometry exploiting the free space around the area as long as safety clearance distances are maintained. In such examples, the fraction of current conducted by the surface area of the outgrowing conductor portion is very small if not zero.

An example of a portion of a conductor that is only used for conducting a current may in principle not be possible in that heat dissipates even from a solid block and a planar surface. What should be understood by a portion of a conductor primarily used for conducting current, is a varying structure or geometry for a middle segment of the conductor between the first and second terminals. When space is narrowed between components in an electrical system, if other conductors are to be passed, if the conductor has to pass through a current sensor or bushing, etc., the surface area of that particular portion of a conductor middle segment may be reduced to comply with available space, thereby typically increasing the conductor density to achieve a narrower outer dimension. In this example, at this particular portion of the conductor, the current conducting portion of the surface area of the conductor becomes high; possibly so high that a hot spot is created where additional cooling is required to continue to maintain a certain current conduction capacity. Hence, this is an example which may benefit from a combination of the conducting portion with an outgrowth portion, as described above, e.g. on each side of the narrowed part of the conductor. In this way, heat generated at the narrow space can be dissipated via the nearby outgrowths, e.g. further in combination with internal cooling channels.

An example of a portion of a conductor that is used for both heat dissipation and current conduction is a middle part between the terminals, with an airy design or geometry. In such example, the surface areas having the main purpose of dissipating heat and conducting current, respectively, may be the same or close to be the same. This is due to a geometry comprising conductor branches spaced apart from each other so that a flow of cooling air may pass freely by each conductor branch, i.e., through air gaps defined by the conductor branches. In this example the current conducting surface area is large compared to traditional conductors/busbars and windings e.g. of an electric motor. Another difference between a motor winding and a conductor of the present may be found in the circumference of the conductor. The limited space inside a motor obviously limits the circumference of the winding. This is not the case to the same extent e.g. in an electrical cabinet comprising a conductor of the present invention. More space is available and thus the circumference can be made larger leading to an airy design with airgaps for increased cooling. Further, the cross-sectional area of the individual conductor branches of a conductor according to the present invention is often lower than the cross-sectional area of a motor winding.

As mentioned, the electrical conductor 1 may comprise first and second ends 2, 3 spaced apart by a middle segment 4. One complete or final electrical conductor may comprise a plurality of interconnected electrical conductors 1 of the types illustrated/described above. In such embodiment the illustrated electrical conductors may be used as sections of the final or complete electrical conductor. Thus, a final or complete electrical conductor may comprise first and second ends 2, 3, with a plurality of first and second terminals 7, 8 at the ends or between them, e.g. with terminal holes 10 for connecting a plurality of the illustrated/described electrical conductors to form the final or complete electrical conductor.

The terminals 7, 8 may comprise one or more terminal holes 10 or other structures for connecting the electrical conductor 1 to other electrical conductors such as busbars, cables or the above-described electrical conductors, electrical components such as breakers, power modules, batteries, etc.

Alternatively, in an embodiment, one or both of the terminals 7, 8 of the electrical conductor 1 form part of an electrical component as an alternative to being provided as freely connectable locations at the conductor 1.

A terminal 7, 8 may in a simple embodiment comprise a terminal hole 10 through the terminal 7, 8. Via such hole, a bolt can go through and continue through a component with which the electrical conductor 1 is to be connected. The electrical conductor and the component are then clamped together via a nut and the bolt.

Alternatively, a terminal 7, 8 may be a click terminal that is either designed to receive a click part form a component to which the electrical conductor is the be connected or designed with a click part that is to be inserted into such other components.

Alternatively, a terminal 7, 8 at an end 2, 3 of the electrical conductor may be manufactured with a threat which when engaging with a bolt is able to assist in clamping a component to the electrical conductor 1.

Further, it should be noted, that an electrical conductor as illustrated or a complete electrical conductor comprising a plurality of electrical conductors such as the above described may have more than one first end 2 or more than one second end 3. Hence, one end of an electrical conductor 1 may branch off in e.g. three terminals each with a terminal hole. This may be advantageous in that the geometry of the electrical conductor is then designed specifically to the component to which it is to be connected. Branching off the ends into several terminals may also improve heat dissipation capacity at the possibly denser terminal portions, improve electrical connection between the conductor and components, and avoid additional connection pieces or shunts in order to connect adjacent components to a common conductor.

The middle segment 4 may comprise one, but preferably a plurality of conductor branches 5. The conductor branches 5, like the end segments 2, 3, are at least partly made of an electric conductive material such as copper or aluminium or alloys thereof, enabling the electrical conductor 1 to conduct a current between its terminals 7, 8. The design of the conductor branch(es) 5 may be optimized according to a specific purpose such as cooling, material consumption, flexibility (control in a particular direction), footprint, etc. Thus, depending on which parameter(s) the electrical conductor 1 is designed according to, the conductor branches may be designed as longitudinal cylinders (or other geometries such as oval, square, etc.), web, bionic, gyroid-like design, lattice-like design, branch-like design, or sponge-like design, coil or solenoidal designs, spirals, etc.

Thus, the electrical conductor may have a perforated surface, a non-perforated surface, a massive structure or a structure with internal channels optimizing the electrical conductor according to skin-effect and cooling, etc.

Two or more conductor branches 5 may meet in an intersection point 9 and two or more conductor branches 5 may branch off from an intersection point 9. This has the effect, that an electrical conductor is established that maintain a desired strength (determined yield point) with a minimum of material. Among others, this may reduce the cost of the electrically conductive material and reduce the weight of the conductor. It should be mentioned that two conductor branches meeting in the intersection point 9 may be the same two conductor branches leaving that intersection point 9. Alternatively, two other conductor branches may leave the intersection point, however this may be a question of definition of a conductor branch. Further one conductor branch may branch off to a plurality of conductor branches and a plurality of conductor branches may converge or meet in an intersection point and form a lower number of conductor branches.

Accordingly, the electric conductor 1 may comprise one first conductor branch 5 that may branch off to a plurality of second conductor branches 5, each of these second conductor branches may further branch off to a plurality of third conductor branches 5 and so on through the middle segment of the electric conductor 1. In this way, following the direction of the current flow through the electric conductor 1 from a first end to a second end, current is allowed to flow in the first conductor branch, then allowed to divide into a flow in the second conductor branches and again allowed to divide into a flow in the third conductor branches and so on into additional nth conductor branches.

In an embodiment, if current is flowing from a first end segment to a second end segment, the first conductor branch may have a first cross-sectional area, the second conductor branches may have a second cross-sectional area which is smaller than the first cross-section area. Following, the third conductor branches may have a cross-sectional area smaller than the second cross-sectional area. Accordingly, the cross-sectional area of the conductor branches may be varied in size in the longitudinal direction of the middle segment.

As described above, the conductor branches of the electric conductor may branch off into a plurality of additional (nth) conductors. In the same way, the conductor branches may also converge from a higher number of conductor branches into a lower number of conductor branches.

It should be mentioned that a cross-sectional area of the middle segment at one distance from a first end segment may be the same as a cross-sectional area of the middle segment at a second distance from the first end segment while the number of conductor branches at the first distance is different from the number of conductor branches at the second distance.

Further, it should be mentioned that the cross-sectional area of the middle segment at the first and second distances from a first end segment may be different while the number of conductor branches may be the same. Of course, the cross-sectional area and the number of conductor branches may also be the same at the first and second distances from the first end segment.

The branching off may be in one plane. This plane may be of a tangent to the surface of an electrical conductor having a curved design. Further note that such branching off may either be at the within the fixed uniformity of the conductor and/or it may be from one conductor to another e.g. via a joint/fixing of two conductors.

It should be mentioned that embodiment of the electrical conductor may also include designs where the conductor branches branch off from the first end segment to a plurality of conductor branches and converge again into the second end segment without branching off between the first and second end segments.

Further, it should be mentioned that the electrical conductor 1 may be designed as a plurality of electrical conductors, e.g. as a combination of three phase conductors or as a wire harness or printed circuit board traces of a printed circuit board used for mounting in an electric panel.

At least a first end 2 and a middle segment 4, but preferably also the second end 3, of the electrical conductor 1 of the present invention are monolithically formed, since they are manufacturing from a single bulk of material, which is machined to provide the electrical conductor 1. Here bulk of material should be understood as the material such as electrically conductive material of which the electrical conductor 1 is made, e.g. a solid, powder, liquid, wire, etc. Here machined should be understood as manufactured by additive manufacturing, i.e. the electrical conductor 1 is made in one piece without any mechanical connections of the first end 2, second end 3 and middle segment 4.

Note that more than one type of material, e.g. two bulks of material, may be used to manufacture the electrical conductor. One of such two or more bulks of material may be electrically non-conductive.

Note that in some embodiments it may be necessary to manufacture the electrical conductor in more than one piece. In this situation the electrical conductor may be referred to as a complete or final electrical conductor which comprises a plurality of electrical conductors 1 as described above. This may be the case e.g. if the electrical conductor needs to be mounted in a location where it cannot be inserted unless the electrical conductor is separated in two or more pieces or if the complete electrical conductor has to be larger than what is possible to manufacture by additive manufacturing. In such situation, terminals of two electrical conductors are connected, extending the length of the middle section and thereby the current path between the first end 2 and the second end 3 and thus of the complete electrical conductor. Such connection may be prepared by designing terminal holes in the conductor where, e.g., fish plates or other joints may be fastened and thereby connecting the two middle segments.

It should be noted that the electrical conductor 1 may have a non-uniform geometry/design. The design/geometry may take any machinable/printable shape. Such shape may be optimized according to conducting current (skin effect), cooling, guidance of flow of cooling fluid, other components in a panel, resistance, power loss or current displacements, etc.

In a particular embodiment, the electrical conductor 1 may have a non-uniform diameter (measured in a transversal direction) along the lengthwise direction. A well-defined diameter may nevertheless be determined e.g. at a transversal plane at which that electrical conductor 1 has its smallest diameter.

Moreover, in an embodiment of the invention the perimeter length of the electrical conductor 1 or its conductor branch(es) 5 may vary in transversal planes at different positions in the lengthwise direction of the electrical conductor 1. The perimeter length of a given part of the middle segment may simply be measured as the sum of all lengths of perimeters of branches in a given transversal plane. Hence, the perimeter length at a given part may thus be the length of the perimeter of conductor branches measured across/perpendicular to the longitudinal direction of the electrical conductor at that part. A part of a conductor may also be referred to as a portion of a conductor and should be understood as a reference to a specific portion of the conductor such as an end or middle segment.

The perimeter length of the conductor branches 5 may be the sum of lengths of perimeters of all individual conductor branches 5. As one conductor branch may split from a stem to two or more twigs, i.e. branches of a branch, the perimeter at one part of the conductor branch may be different from one part (e.g. a twig part) to another part (e.g. a stem part). Hence, the sum of lengths of perimeters of the conductor branches may be the sum of all individual twigs or of all the individual stems. In case of multiple different possible perimeter lengths for the conductor parts along the length of the electrical conductor, the smallest perimeter length may preferably be used in calculation of current conduction capability of the electrical conductor 1.

In the same way, the cross-sectional area of an electrical conductor at a given part is measured as the sum of the cross-sectional area of all conductor branches at a given part along the length of the electrical conductor. The cross-sections at that part should be measured perpendicular to the longitudinal direction of the electrical conductor.

In an embodiment, the electrical conductor 1 may comprise one or more cooling channels, where the cooling channel may be placed inside the one or more conductor branches, transversally and/or longitudinally.

The manufacturing of the electrical conductor 1 may be done by an additive manufacturing process. Such manufacturing process may be based on, but not limited to, one of the following additive manufacturing processes: 3D printing, layer by layer printing, Wire Arc Additive Manufacturing, Fused Deposition Modeling FDM, Direct Energy Deposition, Direct Metal Deposition, sintering based processes, laser based processes, for example Powder Bed Fusion PBF, such as selective laser melting SLM or selective laser sintering SLS, cold spray additive manufacturing CSAM, binder jetting or binder jet 3D printing, etc. It should be mentioned that the actual additive manufacturing process used to print or build the electrical conductor 1 may not be important as long as the material of which the electrical conductor is built is an electrically conductive material.

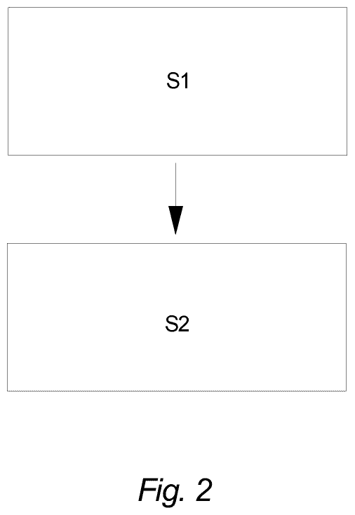

FIG. 2 illustrates method steps for machining an electrical conductor 1 according to an embodiment of the invention. The particular method relates to forming an electrical conductor with two ends or two terminals, namely a first end/terminal and a second end/terminal via a middle segment, but may be used for producing any kind of electrical conductor of the present invention.

It should be mentioned that this may include manufacturing both ends and the middle segment in one process. Hence, with additive manufacturing along the longitudinal direction of the conductor, the method may start by manufacturing, such as printing, one end, then a transition to the middle segment, possibly one or more conductor branches, then the middle segment, then a transition to the second end and finally the second end. In another embodiment, the additive manufacturing occurs transversal to the conductor's longitudinal direction, thereby for example manufacturing portions of both ends and the middle segment simultaneously, increasing the cross section with each applied layer. In another embodiment, the additive manufacturing is radial, or even arbitrary, to the conductor's longitudinal direction, for example using cold spraying CSAM or Fused Deposition Modeling FDM while rotating or freely moving either the conductor unit being built or the nozzle, or both. Preferably, the mentioned segments are manufactured in one process, e.g. as one segment is manufactured, the next segment is being manufactured. A transition part may be made between such two segments which may start or include the first segment. Similarly, the second segment may Ie a transition part or is connected to such transition part.

It should also be mentioned that the method could in some embodiments comprise manufacturing the middle segment and afterwards connect the end segments. The end segments could be connected while being additive manufactured or could be connected with an additive manufacturing paste or glue after being made. The end segments could also be welded, glued or connected in any other way to the middle segment, e.g. by cold spraying CSAM.

An additional embodiment of the invention could be a manufacturing method that comprises two or more middle segments being additive manufactured. The two or more middle segments could be additive manufactured in the same process with the two end segments to form the electrical conductor. The two or more middle segments could also be additive manufactured separately and connected afterwards to form the electrical conductor.

The two or more middle segments could be identical or could be two differently shaped or otherwise characterized middle segments depending on where the electrical conductor should be placed in e.g., an electrical cabinet.

A transition may straightforwardly be defined as a change of size of a layer compared to a previous layer. In this way a transition may be formed as a perpendicular transition between an end segment and a conductor branch of the middle segment. Alternative, subsequent layers may change in cross-sectional area and thus form a transition as a rounded transition which may be advantageous in terms of a reduced resistance for current conducted between the ends of the electrical conductor.

A monolithic conductor according to the present invention is made from one material. One or more additional materials may be used e.g. as isolation, for heat dissipation, etc. in this case the conductor may be referred to as a polylithic conductor. No matter the number of materials, a conductor produced by additive manufacturing is produced bit-by-bit starting at a first spatial coordinate (x, y, z) and ending at a second spatial coordinate. At least when the conductor is finished the first and second spatial coordinates are electrically/mechanically connected. As mentioned several methods of manufacturing a conductor exists all including some kind of material depositing, joining or soldering to manufacture a conductor in one monolithic form.

In this document a conductor may be referred to as being manufactured layer-by-layer no matter the additive manufacturing method used. Hence, if a conductor is sliced (no matter in which orientation) and one is looking at the cross-section of the conductor it is easy to imagen that the conductor is manufactured starting with material in first point, then with material in a second point and so on. Since the conductor is volumetric i.e. has a three dimensional geometry the first point is different from the second and subsequent points at least in one of the spatial X, Y and Z directions/plans. Thus, with reference to the spatial X, Y and Z planes a conductor could be said to be built from a plurality of subsequent layers even though when manufactured all material in one plane such as X=1 and Y=0 and Z=0 is not provided as a one layer or in one layer before material in a next layer (e.g. an X=2 layer) is provided.

Hence, no matter which of the processes of manufacturing a three-dimensional object such as a conductor that is used, it can be said that the conductor is manufactured layer-by-layer even though some of these manufacturing processes are based on deposited, joined or solidified with material being added together in areas, lines, pointwise, etc. This is because no matter the additive manufacturing process the conductor is manufactured one point after the other. A plurality of points in the same plan (e.g. X=3) is considered one layer also if they are not physically connected in this plane. And when all points of this layer are added, points of the next layer (e.g. X=4) is added to the points in the X=3 layer. As mentioned, a layer may be defined in any of the planes of a spatial Cartesian coordinate system.

Alternatively, the ends may be separate segments that are connected via the middle segment. The middle segment may be printed, and during the manufacturing of the middle segment it may be attached to the ends such as printed, heated, glued or the like onto the ends. The middle segment may be joined to the ends by means of welding, printing, soldering, etc.

It should be noted that the ends may comprise terminals for connecting the electrical conductor to other electric parts/conductors/windings of an electric system. Such terminals may be manufactured like the rest of the electrical conductor by additive manufacturing i.e. monolithically formed with the ends.

In a step S1 of this particular method, considering additively manufacturing a conductor in its longitudinal direction from the first end towards the second end, the first end segment and middle segment in the form of conductor branches of a plurality of conductor branches are monolithically formed via individual transitions that may or may not include rounded connections to shape concavely rounded interior corners between the first end segment and conductor branches of the plurality of conductor branches and to spatially separate conductor branches of said plurality of conductor branches.

The step of monolithically forming the first end segment and conductor branches may be implemented using various methods, for example methods such as additive manufacturing such as 3D printing, casting, and simply removing of material, via machining, from a bulk metal slab to form conductor branches combined with a first end segment.

More specific, a known massive conductor such as a main busbar with a length of e.g. 3-5 m may conduct 1-2 A per mm2. If the same busbar was made in an airy design and e.g. with an internal cooling, then due to the improved cooling the same 1-2 A per mm2 may be conducted with the same efficiency despite the removal of material. Typical conductor materials such as aluminium and copper have temperature coefficients at approximately 0.4%/deg C. If such conductor is efficiently cooled so that the temperature is e.g. 25 deg C. lower compared to a conventional conductor, the resistance is reduced by approximately 10%. Hence approximately 10% of the material can be removed without compromising the losses. Furthermore, in AC conductors the current is not evenly distributed across the conductor volume. Typically, the current density is reduced towards the center of the conductor. Taking such considerations into account can allow for further removal of material without compromising the efficiency of the conductor.

In a step S2 of the method, the first end segment becomes electrically coupled and mechanically coupled to a second end segment via the middle segment of the electrical conductor formed by the plurality of conductor branches. This may also be monolithically achieved, e.g. by continuing the additive manufacturing, as described in step S1.

The coupling of the end segments to the middle segment could also be done by welding, gluing, male/female locking mechanism or any other way that would connect the segments both mechanically and electrically.

An optional, additional step of the method of manufacturing the conductor of the invention comprises a step prior to the step of additive manufacturing any of the first, second or middle segments. The step prior to manufacturing the electrical conductor is a step where a digital representation of the electrical conductor is designed in a software program, e.g. a 3D CAD software. The step of designing the digital representation of electrical conductor in a software program includes taking the electrical, mechanical, structural, geometry and other aspects of the physical electrical conductor into account. Thus, based on these inputs, e.g. provided by a user of the 3D CAD software, a digital representation of the conductor is provided by the 3D CAD software. When the digital representation of the electrical conductor is complete the additive manufacturing process can be started.

A further optional step may be applied i.e. a heat treatment to the finalized conductor. A heat treatment may e.g. be 4 hours at 400 C. and upwards depending on the material. An advantage of heat treatment is that the particles of the manufactured conductor is mutual positioning or merging leading to higher conductivity both thermal and electrical. This is at least true for Aheadd® CP1 20/63 aluminium powders and other aluminium-iron-zirconium powder solutions. Such powders may be used in laser powder bed fusion machineries. Using this type of powder and heat treatment may lead to higher thermal stability, thermal conductivity, corrosion performance and surface finishing as well as higher electrical conductivity.

The middle segment may in principle have any design/geometry, for example providing flexibility thereto allowing the electrical conductor to deform. It may be formed by conductor branches being solid or having internal cavities to reduce the amount of material that is needed to manufacture the electrical conductor. It may be formed by a web or as a hybrid between conductor branches or web just to mention a few possible designs.

Internal cavities may be used as cooling channels and/or additional surface for conducting high frequency current. Accordingly, the end segments and middle segments may be designed for the particular panel/electric system in which it is used, for a particular type of current to conduct, for having a desired or dual functionality, etc.

One such functionality, beside the above-mentioned may be as a structural support. Hence, if needed the electrical conductor may be designed to assist in carrying the weight of electric components connected thereto. Hence, its dimensions may be larger than what is needed by it for carrying the required current. Similarly, its geometry may be designed for the combined purpose of mechanical support and electric conductance. This is especially true if such support is flexible/deformable in that it may both assist in supporting and at the same time assist in absorbing vibrations.

It should be mentioned that the electrical conductor 1 may be manufactured in two or more resolutions. The thicker layer the faster manufacturing. The layer thickness depends on the material and printing apparatus and may vary from a few millimetres to 20 um, using some combinations the layer thickness is between 50 um and 150 um. In case of additive manufacturing resolution may be defined by thickness of the layers of which the electrical conductor is built (another word for machined and processed). A first resolution that is finer i.e. having thinner layer size than a second resolution may be used when manufacturing the interface between the electrical conductor and the part to which it is connected. Such interface may be the part of the terminal that is in contact with the other part. Alternatively, resolution may be determined by material deposition rate, material flow rate, etc. depending on the type of additive manufacturing used.

To avoid electric losses in connections between two electrical conductors it is preferred that the two parts have mating surfaces, which is most simply achieved by having planar surfaces, but may also be achieved by convex and concave combinations, mortise or finger joints, engaging teeth, cylinder and peg, tongue and groove, slide lock, etc., to further achieve additional advantages, e.g. larger surface area of connection, easier assembly of electrical conductors such as busbars in electrical systems by self-locking, etc., as long as good electrical connection is prioritized. The finer these interfaces are manufactured the better/the less post manufacturing processing is needed to ensure sufficiently mating surfaces, such as planar surfaces.

The second resolution manufactured e.g. with thicker layers would be more rough leading to more surface area. At least for middle and high frequency currents this may lead to conductance of more current without increasing the need for material/dimensions of the conductor. In fact, the middle segment may be manufactured intentionally with a corrugated surface to increase the current-carrying outer surface of the electrical conductor (current-carrying with medium and high frequencies) because of more efficient cooling due to the turbulence of, e.g., cooling air flow created due to the corrugated surface. It should be noted, that if the conductor includes an interior space, the inner surface of the conductors creating such interior space may also be corrugated for the same purpose. A corrugated surface has the effect, apart from offering a larger surface area, that it introduces turbulence in the flow of cooling fluid such as air. Increased speed of cooling fluid may lead to higher cooling effect.

As an example, the depth into the conductor which is used for conducting current at medium and high frequencies may in a specific embodiment be approximate 1.5 mm. In this specific example, the conductor is made of copper with a resistivity of approximate 1.68 μΩ cm, a relative permeability of approximate 1 at a frequency of 2kHz. Thus, a conductor for this particular embodiment may be hollow having conductor thickness of 2 times 1.5 mm. In practice such conductor may be manufactured with a thickness of 4-5 mm leaving room for a cooling in the interior or simple reduction of conductor material and thereby weight.

Knowing that skin effect also appears at e.g. 50 Hz, a reference to a medium frequency with respect to skin effect is a reference to frequency starting around 500 Hz where the design of the conductor may account for the skin effect. The medium frequency range may be between 500 Hz and 10 kHz, above 10 kHz may be referred to as high frequency where skin effect is a fact (the higher frequency, the closer to the surface the current will be conducted).

Further, it should be mentioned that the outer surface may also be corrugated or designed with fins for increasing heat dissipation from the electrical conductor.

The electrical conductor resulting from the method may be used as an electrical conductor of an electrical installation. The electrical installation may be an electric panel which may be part of a renewable energy facility such as a wind turbine, solar system, grid, substation, etc. The electrical installation or system in which the electrical conductor is used may be an electric vehicle, battery system, power to x facility, ship or other minor or larger electric systems. Further, an electrical conductor resulting from the method can be used inside an electric panel, i.e. in a cabinet/enclosure, or outside such panel, it can be used to connect separated panels, etc.

A variant of an electrical conductor according to the present invention is connected to a traditional cable or busbar. In such embodiment, a traditional busbar e.g. in the back of an electric panel or a traditional cable e.g. between two electric panels may be connected to an electrical conductor of the invention. In this way a traditional cable or busbar may be connected to a component via a conductor according to the invention. Thereby, an easy connection is facilitated due to the flexibility of the electrical conductor of the invention.

However, note that manufacturing the electrical conductor, and thus accomplishing the electrical and mechanical coupling between the first end segment and the second end segment, is typically performed prior to installing the electrical conductor in the electrical installation, and prior to installing the electrical installation in the renewable energy facility. Thus, according to typical embodiments of the invention, the electrical and mechanical coupling is performed prior to installation/integration of the electrical conductor. Nevertheless, methods according to the invention are not necessarily restricted to a particular sequence of steps. Further, various methods according to the invention may comprise additional steps, such as performing digital geometry optimization, additively manufacturing the electrical conductor, and conducting current.

Summing up, a designer is designing a digital representation of the conductor according to electrical, mechanical, structural, etc. requirements in e.g. a 3D CAD software such as Solidworks. Files (digital representation) from such 3D developing tool is exported to e.g. a 3D printer, where the conductor is printed according to the CAD files.

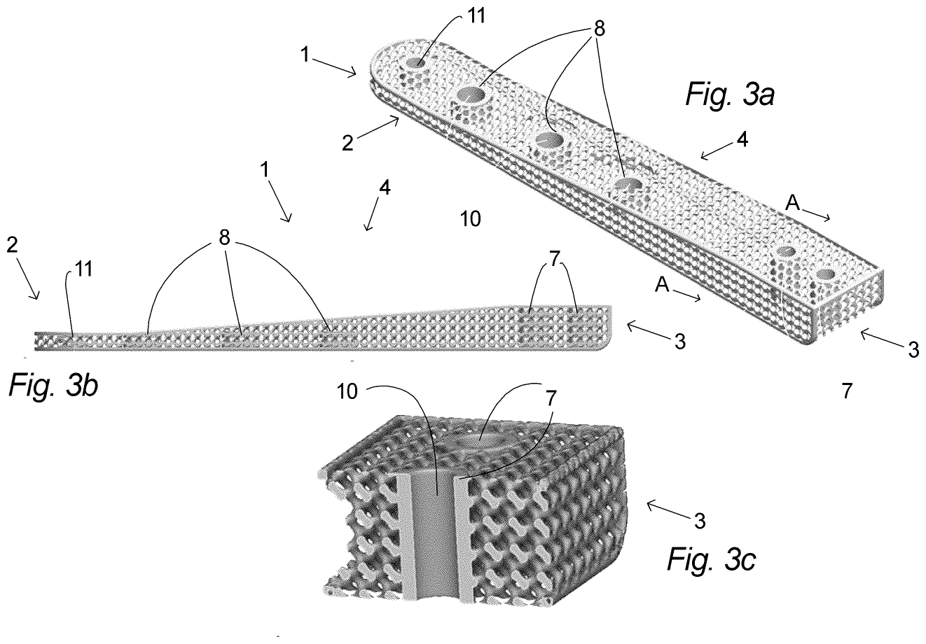

FIG. 3a-c illustrates an embodiment of the invention, where the electrical local connecting busbar 1 has a geometry shaped as a wedge. The electrical local connecting busbar 1 (also referred to as electrical conductor or busbar) comprises a first end 2 and a second end 3 where the second end 3 being distal to the first end 2 and spaced apart from each other by a middle segment 4. The electrical conductor 1 is made of an electrically conductive material.

Compare to the electrical conductors illustrated in FIG. 1a-1c, the electrical conductor 1 illustrated in FIG. 3a differs in that it comprises two first terminal 7, three second terminal 8 and a fastening hole 11. These terminals are positioned along the length of the electrical conductor 1 i.e. in the direction the current runs through the electrical conductor 1. The current runs from the three second terminals 8 to the two first terminals 7 along/through the middle segment 4. The two first terminals 7 and the fastening hole 11 serves to support the busbar. The fastening hole 11 may be to some a mechanical structure different from a busbar/conductor and the terminals 7 may be to mechanical structure such as a busbar/conductor. The holes 7, 11 may be perpendicular to the direction of the current through the conductor.

The electrical conductor 1 is thicker in the part where the first terminals 7 are located due to the amount of current running in the electrical conductor 1. As the current conducted by the individual of the three second terminals 8 sums up the total current increases towards the first terminals 7 and hence the thickness of the electrical conductor 1 towards the first terminals 7 increases. Put in another way, the thickness and thus the material consumption can be reduced towards the end of the conductor 1 which conducts 0 A or only current from one cable connected to the first of the second terminals 8.

As mentioned, the electrical conductor 1 shows a fastening hole 11 in the second end 3. The hole 11 is for fastening the electrical conductor 1 in e.g., an electrically cabinet. It is very important to secure the electrical conductor 1 mechanically tight, so the electrical conductor 1 is not affected by vibrations in the system. The fastening to the electric cabinet is isolated. A tight mechanically connecting is also important between the two first terminals 7 and the busbar they connect to, to have a better electrically connecting from the electrical conductor 1 to e.g., the rest of the system in the electrical cabinet which in this case may be another busbar.

The embodiment illustrated in FIG. 3a is shaped with plane sides on the sides along the length of the electrical conductor. The sides could also be concave shaped along the length of the electrical conductor 1 as seen in FIG. 3c, to use less material for the electrical conductor 1. The concave surface could be configured for cooling the electrical conductor more sufficient in that a flow of air is directed into the concave surface and there guided into the airgaps 6 of the structure of the conductor 1.

FIG. 3b illustrates a side view of the electrical conductor 1, where both the fastening hole 11 and the terminal holes 10 are illustrated through the weblike structure of the electrical conductor 1. FIG. 3b illustrates the difference in height between the first end 2 and the second end 3.

FIG. 3c illustrates the electrical conductor in a cross-sectional view as seen from perspective A in FIG. 3a. The electrical conductor in FIG. 3c illustrates the concave surface along the longitudinal length of the electrical conductor 1. FIG. 3c also illustrates the higher density of the electrical conductor around the terminal hole 10. The higher density around the terminal hole 10 is similar to the both the fastening hole 11 and the terminal holes 10 in the electrical conductor 1.

Note that the through-hole through the conductor defining the terminals holes 10 and/or fastening holes 11 has a solid wall. The solid wall may be of the same or different material as the rest of the conductor and be used to provide strength to the terminal/fastener hole when these are used e.g. to bolt two conductors together or fasten the conductor. The cross-sectional area of the solid wall is determined by the force which e.g. a bolt is applying to the conductor to sufficiently securing the conductor. As an example, the cross-sectional area of the solid walls may be between 0.2 mm and 20 mm such as between 0.3 mm and 15 mm, such as between 0.4 mm and 10 mm such as between 0.5 mm and 0.8 mm.

If the solid wall of a fastening hole 11 is made of the same conducting material as the conductor, the diameter of the fastening hole 11 may be large enough to allow an insulating bushing between the conductor material and the bolt. Such insulating bushing may comprise a collar resting on the surface of the conductor and thereby insulating the bolt head from the conductor material. Such bushing with collar may be manufactured by additive manufacturing. Alternatively, the solid part of the fastening hole 11 can be made of an electrically insulating material. electrically insulating material in form of a filament, e.g. made of thermoplastics such as polylactic acid PLA or acrylonitrile butadiene styrene ABS filament.

FIGS. 3a and 3c illustrates that for both the fastening hole 11 and the terminal holes 10 the density of the electrical conductor used in the electrical conductor is greater than the rest of the electrical conductor. For both types of holes, the electrical conductor is strengthened around the holes for securing a better fastening of either the electrical connections or the mechanical connection. The holes also comprise an installation surface to secure the fastening of both the electrical connections and mechanical connections to secure the electrical connections and for fastening the electrical conductor.

The fastening hole 11 could be said to disturb and reduce the cross-sectional area of the current path through the conductor. Therefore, when removing the electrically conductive material for establishing a fastening hole an additional amount of material is preferably added to the electrical conductor. The added material around the hole is added to maintain the cross-sectional area throughout the conductor 1 for the electrical current running through the electrical conductor.

Additionally, the structural property of the electrical conductor is preferably strengthened around the fastening hole 11 and the terminals 7 this may be done by providing a cylinder like fastening hole 11 and terminals 7 which is solid throughout the busbar. In this way the clamping can act on this cylinder and not on the less strong web-like structure of the illustrated design of the busbar 1.

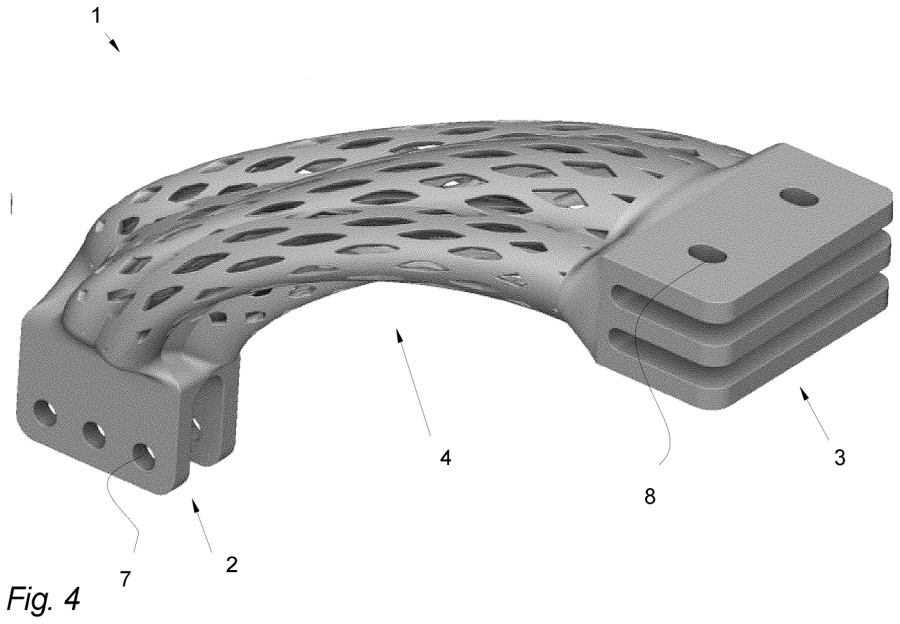

FIG. 4 illustrates an electrical conductor such as e.g. a transition or main busbar having end segments 2, 3 of an U-shaped and E-shaped design. It should be noted that the middle segment of a first conductor towards one or both ends may split and thereby divide the end(s) in two parts. Such split may form a U-shaped end section. Such U-shaped end section together with the middle segment may form a conductor having an Y-shape towards one or both of the ends. This is in FIG. 4 illustrated towards the first end segment 2. Such two parts may then at least partly enclose a middle segment or an end of a second electrical conductor to which the first conductor is to be connected. In this way the split end(s) 2, 3 provide a set of terminal holes 7, 8 allowing a bolt to pass through both holes of the terminal and a through hole in the conductor while fastening the first and second conductors. In an embodiment, the first conductor may be a transition busbar and the second may be a main busbar.

In the same way, the fastening holes may also be implemented e.g. as a U-shaped part of e.g. an end segment or separate fastening segment or area of the busbar.

It should be noted that such alternative end segment design may be shaped in various forms including an E-shape such as the second end segment of FIG. 4 configured to receive and enclose two end segment parts. These may be from one or two different busbars. In fact, at the outer parts of such E-shaped end segment, additional end segments may be connected. Hence, an end segment with an alternative design may facilitate connection of several individual busbars.

Hence, U-shaped and E-shaped end segments may facilitate a sandwich-type connection of end segments of two or more busbars reduction electrical losses in the connection. An alternative connection of end segments could be circular, a triangular, square or multiple angular shaped. When end segment designs with such shapes or geometries are made so that the fit each other such as one can be inserted in the other, the busbars having these end segments can be connected with a turn-and-lock type of fastening. This may include recesses and associated protrusion which interlock the tow end segments when joints and turned or displaces. In addition, a bolt or similar may be provided to ensure the end segments are maintained in the interlocked position.

The conductor of the present invention illustrated in FIG. 4 being manufactured by additive manufacturing may be manufacture as a curved conductor. i.e. no post processing is needed to bend the conductor. The curve is typically 90 degrees as illustrated in FIG. 4 or less, but could in principle be any angle. Such curved conductor may reduce number of connections in a panel and thereby mounting time and also losses in connections conductors.

Further, the conductor of the present invention illustrated in FIG. 4 being manufactured by additive manufacturing may be twisted between 1 degree and 359 degrees. In this way the end segments may be oriented differently and fastened e,g, to other conductors with bolts that are having non-parallel center axis. This is leading to a more flexible design of the layout in a panel and sometimes also easier mounting of the conductors in a panel.

In an embodiment, the middle segment 4 comprise a plurality of parallel conductor branches 5. The part of the conductor branches 5 that are parallel are only or at least 2 cm. The parallel parts of two (or more) conductor branches may be parallel at the same or overlapping distances from the first or second end segments. Alternatively, such parallel parts may not overlap and thus extend at different distances from the first or second end. A non-limiting example may be a first conductor branch having a part starting 3 cm from the first end segment and ending 8 cm from the first end segment. A second conductor branch may have a part starting 9 cm from the first end segment and ending 10 cm from the first end segment. Even though the parts of the first and second conductor branches do not overlap along the longitudinal axis of the electrical conductor, they may be considered parallel.

Note that a plurality of parts of one conductor branch may be parallel to a plurality of parts of other conductor branches and/or to a plurality of parts of one particular conductor branches along the length of these conductor branches. Hence two conductor branches may be parallel a plurality of times between the two end segments. Further, one conductor branch may be parallel to the longitudinal axis of the middle segment/electrical conductor branch a plurality of times between the two end segments.

A parallel part of one or more conductor branch may extent for at least 10% of the length of the conductor branch/middle segment.

The part of the conductor branches that are parallel may be defined by the surface of two or more conductor branches including tangents to curved surfaces of one or more conductor branches. Alternative or in addition, the parallel part of two or more conductor branches may be the center axis of the conductor branches. Note that more than two conductor branches may be parallel according to the above definition such as between 3 and 100 (or any natural number therebetween) conductor branches.

Further, a conductor branches may be defined as parallel to a longitudinal axis of the electrical conductor, this axis may be defined as the shortest/direct path between a center of the first end segment and a center of the second end segment. Hence one or more conductor branch may be parallel to the longitudinal axis or part of the longitudinal axis of the electrical conductor.

The above design with parallel conductor branches may inherent a plurality of the advantages described in this document. A common advantage of the above described parallel design is a reduction of material, improved or controlled flexibility and improved or controlled cooling including individual cooling of each individual conductor branch preferably from any angle of the longitudinal axis of the conductor branch e.g. via a flow of air or other coolants. In addition, the partly parallel/non-parallel conductor branch design may allow various electrical conductor layout including curved, twisted, bended, etc. layout of the electrical conductor between two terminals to when the first and second end segments are to be connected.

It should be mentioned that conductor branches in embodiments may also extend between two end segments without being parallel, being parallel for a distance below 2 cm, being parallel to each other and non-parallel to further conductor branches, etc.

### LIST

1. Electrical conductor
2. First end
3. Second end
4. Middle segment
5. Conductor branch
   a. Longitudinal conductor branch
   b. Transversal conductor branch
6. Air gap
   a. Longitudinal airgap (in X direction)
   b. Transversal airgap (in Y direction)
   c. Vertical airgap (in Z direction)
7. First terminal
8. Second terminal
9. Intersection point
10. Terminal hole
11. Fastening hole
12. Internal cooling channel

1.-37. (canceled)

38. An electrical local connecting busbar comprising:
a first end segment and a second end segment,
wherein the first end segment includes at least one first terminal, and the second end segment includes at least one second terminal,
wherein the at least one first terminal and the at least one second terminal are spaced apart by a middle segment configured to support conductance of an electric current between the first end segment and the second end segment, having the at least one first terminal and the at least second terminal, respectively,
wherein the electrical local connecting busbar is manufactured by additive manufacturing, and
wherein the first end segment and the second end segment are orientated differently in space.

39. The electrical local connecting busbar according to claim 38, wherein the electrical local connecting busbar is one of: a main busbar, a transition busbar, and a current balancing busbar.

40. The electrical local connecting busbar according to claim 38, wherein the middle segment includes at least one first terminal and at least one second terminal.

41. The electrical local connecting busbar according to claim 38, wherein the middle segment includes a plurality of conductor branch elements.

42. The electrical local connecting busbar according to claim 38, wherein the electrical local connecting busbar is manufactured of a non-electrically conductive material, and wherein the electrical local connecting busbar is coated or painted with an electrically conductive material.

43. The electrical local connecting busbar according to claim 38, wherein the electrical local connecting busbar is manufactured in a geometry that is one of: bionic, web, sponge, honeycomb, wave, gyroid, or branch.

44. The electrical local connecting busbar according to claim 38, wherein the middle segment includes at least one internal cooling channel.

45. The electrical local connecting busbar according to claim 38, wherein the electrical local connecting busbar is a high-power electrical conductor having a resonance vibration frequency of at least 5 Hz.

46. The electrical local connecting busbar according to claim 38, wherein the first end segment or the second end segment is U-shaped or E-shaped.

47. The electrical local connecting busbar according to claim 38, wherein the middle segment includes a curved area or a twisted area.

48. The electrical local connecting busbar according to claim 38, wherein the electrical local connecting busbar is formed with an outer shell structure and a grid structure inside the outer shell structure.

49. The electrical local connecting busbar according to claim 38, wherein the electrical local connecting busbar is manufactured in two or more resolutions.

50. A method of additive manufacturing to form an electrical conductor including a middle segment that has a non-uniform design, the method comprising steps of:
forming a first layer of electrically conductive material; and
forming a plurality of subsequent layers of the electrically conductive material on the first layer, thereby forming a first end, a middle segment, and a second end of the electrical conductor,
wherein a first subsequent layer added to a second subsequent layer, which preceded the first subsequent layer, forms a non-uniform cross-sectional area of the middle segment,
wherein the first end segment includes at least one first terminal and the second end segment includes at least one second terminal,
wherein the first end segment and the second end segment are spaced apart by the middle segment, the middle segment being configured to support conductance of an electric current between the first end segment and the second end segment, and
wherein the first end segment and the second end segment are orientated differently in space.

51. The method according to claim 50, wherein the electrical conductor is braided from a plurality of additive manufactured conductors while being printed.

52. The method according to claim 50, wherein the additive manufacturing is a process of: Cold Spray, Binder Jetting, Stereolithography (SLA), Selective Laser Sintering (SLS), Fused Deposition Modeling (FDM), Digital Light Process (DLP), Multi Jet Fusion (MJF), PolyJet, Direct Metal Laser Sintering (DMLS), or Electron Beam Melting (EBM).

53. The method according to claim 50, wherein the electrical conductor is manufactured so that a dimension of the electrical conductor is manufactured larger than a dimension of a printing volume of a device used for the additive manufacturing.

54. The method according to claim 50, wherein the method further comprises a step of connecting a first conductor and a second conductor including:
providing the first conductor,
providing the second conductor, and
mechanically connecting the first conductor with the second conductor, thereby forming a multi-part electrical conductor.

55. The method according to claim 54, wherein the first conductor includes a male connecting piece and the second conductor includes a female connecting piece.

56. The method according to claim 55, wherein the male connecting piece and the female connecting piece include a cooling channel.
